(19) United States
(12) Patent Application Publication
(10) Pub. No.: US 2003/0101234 A1
(43) Pub. Date: May 29, 2003

(54) System and method for indicating whether a document is cached

(75) Inventors: Gerald F. McBrearty, Austin, TX (US); Shawn P. Mullen, Buda, TX (US); Johnny M. Shieh, Austin, TX (US)

Correspondence Address: Edmond A. DeFrank, 20145 Via Medici, Northridge, CA, 91326, US

(73) Assignee: International Business Machines Corporation, Armonk, NY

(21) Appl. No.: 09/996,125

(22) Filed: Nov. 28, 2001

(51) Int. Cl. G06F 15/16; G06F 17/30; G06F 7/00

(52) U.S. Cl. 709/218; 707/10

(57) ABSTRACT

The present invention is a management process operating on a computer system that has cached addresses and documents stored on the computer system, the process comprising displaying cache status information about the cached documents when a user digitally points to an address associated with one or more of the cached documents. After the user views the cache status information, a user chooses between load options: 1) to load the cached document; 2) to load designated portions of the document either from the cache or with newly loaded and “fresh” content; or 3) to load a completely new or “fresh” document. Further, after the chosen document is loaded, visual indicia (such as a color coding scheme or highlighting) is used to distinguish between the portions of the document that are cached and fresh. The user is then given the three load options again.

### CROSS REFERENCE TO RELATED APPLICATIONS

The present application relates to the subject matter of the following commonly assigned, co-pending U.S. patent application Ser. No. 09/564,817 (IBM Docket No. AUS9-1999-0898-US1), filed on May 4, 2000 by McBrearty et al. and entitled “INDICATOR TO SHOW THAT A CACHED FILE IS BEING DISPLAYED ON A CLIENT SYSTEM” and U.S. patent application Ser. No. 09/564,815 (IBM Docket No. AUS9-1999-0704-US1) filed on May 4, 2000 by McBrearty et al. and entitled “INICATOR TO SHOW THAT A CACHED WEB PAGE IS BEING DISPLAYED”.

### BACKGROUND OF THE INVENTION

1. Field of the Invention

The present invention relates in general to a system and method for displaying web pages on a browser. In particular, the present invention relates to a system and method for providing cache status information about a document, such as a web page, through a user interface when a user rolls a cursor over an address pointing to the document. After the user views the cache status information, the invention then allows a user to make an informed decision to either load the cached document, only portions of the cached document or a completely new or “fresh” document.

2. Related Art

The development of computerized distributed information resources, such as the Internet, allows users to link with servers and networks, and thus retrieve vast amounts of electronic information heretofore unavailable in an electronic medium. Such electronic information increasingly is displacing more conventional means of information transmission, such as newspapers, magazines, and even television. The term Internet is and abbreviation for “Inter-network”, and refers commonly to a collection of computer networking. TCP/IP is an acronym for Transport Control Protocol/Internet Protocol, a software protocol developed by the Department of Defense for communication between computers.

Internet services are typically accessed by specifying a unique address, a universal resource locator (URL). The URL has two basic components, the protocol to be used, and the object pathname. For example, the URL http://www.ibm.com (home page for International Business Machines—IBM) specifies a hypertext transfer protocol (“http”) and a path name of the server (“www.ibm.com). The server name is associated with a unique numeric value (a TCP/IP address, or “domain”).

The Internet has rapidly become a valuable source of information to all segments of society. In addition to commercial enterprises utilizing the Internet as an integral part of their marketing efforts in promoting their products or services, many federal, state, and local government agencies are also employing Internet sites for informational purposes, particularly agencies which must interact with virtually all segments of society, such as the IRS. The information provided is often updated regularly to keep users current with changes, which may occur from time to time.

The World Wide Web (WWW or Web) is a graphic, interactive interface for the Internet. There are different programs that facilitate user scanning and selecting at this interface. The interaction is called browsing, and programs (web browser clients) on a data processing system (which may be a computer) perform this function. A data processing system connected to the Web may access a server (a program on another data processing system) also connected to the Web. The program on the server is generally termed a “web site”. Web sites are a collection of “web pages”, where web pages are graphic displays, which are usually linked together and may be downloaded to a data processing system utilizing a browser client. Each web page has a URL within the Web that is accessible by utilizing TCP/IP transactions via telecommunication networks and a modem. The address allows Internet browser clients to connect and communicate with a Hypertext Transfer Protocol (HTTP) server over the Web.

Retrieval of information on the Web is generally accomplished with a hypertext markup language (HTML) compatible browser. This is an application program capable of submitting a request for information identified by a URL at the client machine. The information is provided to the client formatted according to HTML.

Each Web address (www) specifies or implies a reference to one particular site on the Internet. This means that without some kind of additional machinery, whenever a person requests a specific www address, no matter the location or the number of other simultaneous requests, the call will be made to that specific site, which may lead to an unnecessarily high use of network links and excessive load on servers to popular sites.

High use of network lines and excessive load on popular servers leads to one of the biggest problems currently on the Internet; lack of adequate bandwidth. Information abounds on the Internet, but the delay involved in retrieving that information frustrates the user. Until the Internet infrastructure is upgraded to accommodate greater traffic in similar time frames, Web surfers must look to other means to relieve congestion.

When Web pages are retrieved under direct user control, it is common practice for Web browsers to cache pages accessed. The Network bandwidth is finite. A large volume of traffic to a particular Web site over this bandwidth can make access difficult, and the time the user has to wait for the access is relative to the volume of traffic. Furthermore, Web pages often include sizable graphics files or other large files requiring a substantial amount of time for the transfer of data from the source to the requesting client. Caching Web pages allows the user repeat views of the page within a short span of time without retrieving the Web page each time. It provides a local (or networked) copy of a page previously retrieved off the Internet. This copy can be re-loaded quickly if desired.

Typically, as a user browses documents using the Internet or World Wide Web, the URL or portions of the document being browsed can be stored or cached. Caching is a generic term meaning “to store.” It typically is completed to avert Internet traffic. As applied to the Internet, “caching” means the copying of a document, made incidental to the first access to the page, and storage of that copy for that purpose of speeding subsequent access.

This is done to help speed up the loading of the page if the user visits the page at a subsequent date. This is because loading data from a cache is usually faster than loading data using the user's connection to the World Wide Web. Also, if the document is temporarily unavailable due to Internet congestion or server problems, the cached information can still be viewed locally.

There are many ways of caching a document. Two common ways are referred to as “client caching” and “proxy caching.” Client caches reside within an individual user's browser. Client caching takes two forms: persistent and non-persistent. A persistent client retains its documents between invocations of the browser. A non-persistent client cache removes any memory or disk space used for caching when the user quits the browser.

When the user's computer requests a website, the computer will first check to see if the data requested already resides in the cache. If the cache has a copy of the requested data then the cache provides the data very quickly to the user. If the data is not in the cache, the computer fetches the item needed from the Internet, and also stores a copy in the cache. Now the cache has this data available if the user requests it again. The larger the cache, the more data the cache can store, and the more likely the cache will have the requested item.

Proxy caching takes place on a network used by the World Wide Web (WWW). Proxy caches reside on machines in strategic places (typically gateways) in the network of the WWW. Proxy servers act as intermediaries between local clients and remote content servers. Caching of documents is also performed at proxies. Thus, caching in proxies, which serve an entire intranet, can benefit the entire local network.

When a user asks a client for a Web page, the client heads for the Internet. If there is a caching proxy, client requests go to the proxy server, not to the remote web page. The proxy server checks to see if it has already cached the requested page on the proxy server. If the server had cached a copy of the Web page, the server returns the page to the client directly. Reporting cached information to clients occurs rapidly because it requires reduced Internet activity. Caching reduces the computational load on the remote content server and makes it possible for the server to supply, exponentially, data to more machines. If the sever does not have a cached copy of the requested document, the server goes to the remote Web page server, finds the original, and forwards the data to the client, and simultaneously files a copy in its cache.

Requests for information from a remote Web site, may receive it from a cache (local or proxy). If the cached information is “stale” (the information has been altered since it was cached), the user has received at best outdated information, and at worst, misleading information. The degree depends on the nature of the Web site's content.

A Web site providing stock quotes must be current. Financial and other similar sites may change their information regularly and continuously. Therefore, information present on a Web site when it is first down loaded and cached, may differ vastly from information available when the site is revisited.

While it is possible for a Web page to be updated regularly, this may occur without the user's knowledge. In fact, it is more often the case that the cached page is displayed rather than an updated page. Some pages may have a time/date stamp, and this may require the determination of the page manager to be included in a page display. In other instances, the software/application is set to automatically update the time/date when the page is accessed giving the user the impression that the document has just been retrieved without indicating that the retrieval was from the cache. This protocol is not a reliable indicator to the user of the status of the document being retrieved. To overcome this defect, some Web browsers are typically designed with a “reload” button by which a user may manually override the use of cached data but this is not necessarily a standard feature. User's can not predict if the data is cached when going from browser to browser, or from work station to work station.

Current browser technology allows a page that is trying to be contacted, to be presented from a previously cached page with a pop up notifying its status. However, this notification only covers cases where a server site is unreachable and not when the user is using the “Back” and “Forward” options on a browser. That scenario utilizes heavily cached data with an occasional non-cached page inserted into the path.

Other methods permit periodical retrieval of newer copies of a cached page. A timer may alert the mechanism to down load a new copy of the Web page from the server and store it in the cached location. The copy would be current immediately after the cache retrieval operation.

In other methods a user is provided with the option, of determining on startup, the browser applications, either a cached page or a new version. This method does not indicate if the page has changed, and the user has to wait for an Internet connection even if a cached page was requested.

This is further extenuated by multiple users of a Web browser application. The primary user may set applications to always utilize cached pages. Subsequent users have no way of knowing if a page is a cached page that had been previously downloaded. When a browser needs to download a file through a URL connection, it normally will first check its cache and its caching policy to see if a new version needs to be downloaded. If so, the browser will download the file into the cache, and then read the files directly from the cache.

However, current browsers do not provide enough status information on the documents or pages that are cached to help a user make an informed decision. Namely, some users hesitate to visit certain URLs for fear the documents located at the URLs will take too long to load due to their slow network connection. If the users were aware of when the cached page was cached or what percentage of the page was cached this would help them make an informed decision and enhance their browsing experience. The present invention recognizes and solves these problems.

### SUMMARY OF THE INVENTION

To overcome the limitations in the prior art described above, and to overcome other limitations that will become apparent upon reading and understanding the present specification, the present invention is embodied in a system and method for providing cache status information about a document, such as a web page, through a user interface when a user digitally points to an address, such as a URL, pointing to the document accessible on a browser application.

After the user views the cache status information, the user is provided with load options, for example, either: 1) to load the cached document; 2) to load designated portions of the document either from the cache or with newly loaded and “fresh” content; or 3) to load a completely new or “fresh” document. Further, after the chosen document is loaded, visual indicia (such as a color coding scheme or highlighting) is used to distinguish between the portions of the document that are cached and fresh. The user can then be given the three load options again.

The invention includes a module, such as a computer program, adapted for use with a computer and document browser, such as an Internet browser for World Wide Web browsing and a cache that can be any suitable cache, such as a local software cache residing on the user's hard drive and controlled by the browser (for example, as computer files) of a local client computer or a proxy cache residing on a server remote to the user's computer.

The module is a plug-in component for the browser or a program that runs on a remote server or the user's local computer. The module interfaces with the browser and the cache and determines the availability of the document, date the document was cached and the percentage of the document that was cached. The module stores this information in a table for quick retrieval at a later time. If the module is a plug-in component for the browser, it adds the additional status information to a file managing the cache for later retrieval.

The browser preferably has a graphical user interface with a graphical indicator that is controlled by the module and graphically indicates the gathered cache status information on direction by the module, for example when a predefined event occurs, such as a user digitally pointing to an address (rolling the cursor over a document address with a mouse).

The graphical indicator provides the cache status information within the user interface so that the user is given enough to make an informed decision about whether to visit a certain document located at the particular URL. This will limit user hesitation on whether to visit certain URLs for fear the documents located at the URLs will take too long to load due to their slow network connection.

Hyperlinks representing the addresses or URLs of documents or World Wide Web pages are used in the browser. The graphical indicator is implemented into status bars of typical browsers or is implemented as a navigation box or pop-up chart showing that the page is actually in the cache, together with a record of the percentage and time the page was cached at its last down load for graphically informing the user before he/she decides to visit the document.

### BRIEF DESCRIPTION OF THE DRAWINGS

Referring now to the drawings in which like reference numbers represent corresponding parts throughout:

FIG. 1 illustrates a conventional hardware configuration for use with the present invention.

FIG. 2 is a block diagram showing further details of selected components of the present invention.

FIG. 3 is a detailed flow chart illustrating detailed operation of the present invention.

FIGS. 4A-4B depict a Web browser with a Web page as originally downloaded from the Internet.

FIGS. 5A-5D depict a Web browser with a Web page, which has been previously cached.

FIGS. 6A-6F are diagrams representing a Web browser with Web pages and the process of displaying a newly downloaded page and displaying a cached page.

FIG. 7 depicts a Web browser with a Web page of an alternative embodiment, which has been previously cached.

FIG. 8 depicts a Web browser with a Web page of an alternative embodiment, which has been previously cached.

FIG. 9 is a flow chart of the process involved in displaying cache web pages in accordance with the present invention.

### DETAILED DESCRIPTION OF THE INVENTION

In the following description of the invention, reference is made to the accompanying drawings, which form a part hereof, and in which is shown by way of illustration a specific example in which the invention may be practiced. It is to be understood that other embodiments may be utilized and structural changes may be made without departing from the scope of the present invention.

I. Introduction

In general, the present invention provides cache status information about a document, such as a web page, through a user interface when a user rolls a cursor over an address pointing to the document. After the user views the cache status information, the invention then allows a user to make an informed decision to either load the cached document, only portions of the cached document or a completely new or “fresh” document. The term “cache” used herein refers to commonly available methods to store addresses of documents and the documents visited by a browser, such as client caches or proxy caches.

Client caching involves storing the address and document or portions of the document on the user's hard drive of the local machine and associating it with the user's browser. Client caches include persistent and non-persistent caches. Persistent caches retain its documents between invocations of the browser, while non-persistent client caches remove disk space used for caching when the user quits the browser.

Proxy caching takes place on a network, such as used by the World Wide Web (WWW). Proxy caches reside on machines in strategic places (typically gateways) in the network of the WWW. Proxy servers act as intermediaries between local clients and remote content servers. Caching of documents is also performed at proxies. Thus, caching in proxies, which serve an entire intranet, can benefit the entire local network.

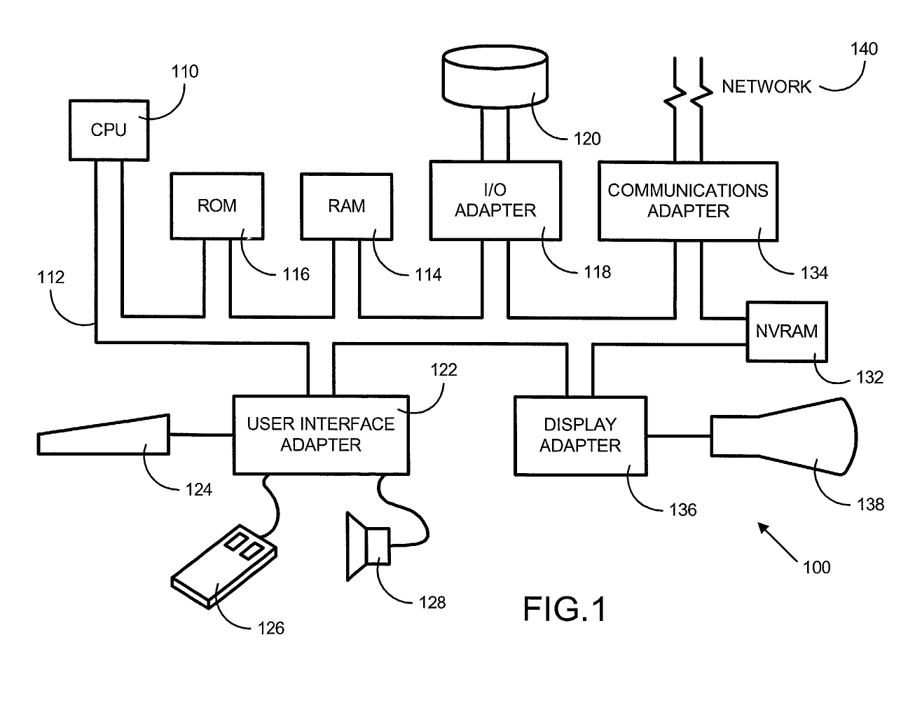

The preferred embodiments may be practiced in any suitable hardware configuration that uses a networked connection, such as computing system 100 illustrated in FIG. 1 or alternatively, in a laptop or notebook computing system. Computing system 100 includes any suitable central processing unit 110, such as a standard microprocessor, and any number of other objects interconnected via system bus 112.

For purposes of illustration, computing system 100 includes memory, such as read only memory (ROM) 116, random access memory (RAM) 114, and peripheral memory devices (e.g., disk or tape drives 120) connected to system bus 112 via I/O adapter 118. Computing system 100 further includes a display adapter 136 for connecting system bus 112 to a conventional display device 138. Also, user interface adapter 122 could connect system bus 112 to other user controls, such as keyboard 124, speaker 128, mouse 126, and a touch pad (not shown).

One skilled in the art readily recognizes how conventional computers and computer programs operate, how conventional input device drivers communicate with an operating system, and how a user conventionally utilizes input devices to initiate the manipulation of objects in a graphical user interface.

The user interface 122 could be in the form of a set of commands and menus through which a user communicates with the computer. A command-driven interface is one in which a user enters commands. A menu-driven interface is one in which a user selects command choices from various menus displayed on the screen. The user interface 122 is preferably a graphical user interface (GUI) that resides within a computer-readable media and contains device drivers that allow one or more users to initiate the manipulation of displayed object icons and text, on a display device. Any suitable computer-readable media may retain the GUI and OS, such as ROM 116, RAM 114, disk and/or tape drive 120 (e.g., magnetic tape, magnetic diskette, CD-ROM, optical disk, or other suitable storage media).

In the preferred embodiment, the GUI may be viewed as being incorporated and embedded within the operating system. Alternatively, any suitable operating system or desktop environment could be utilized.

II Overview of the Components

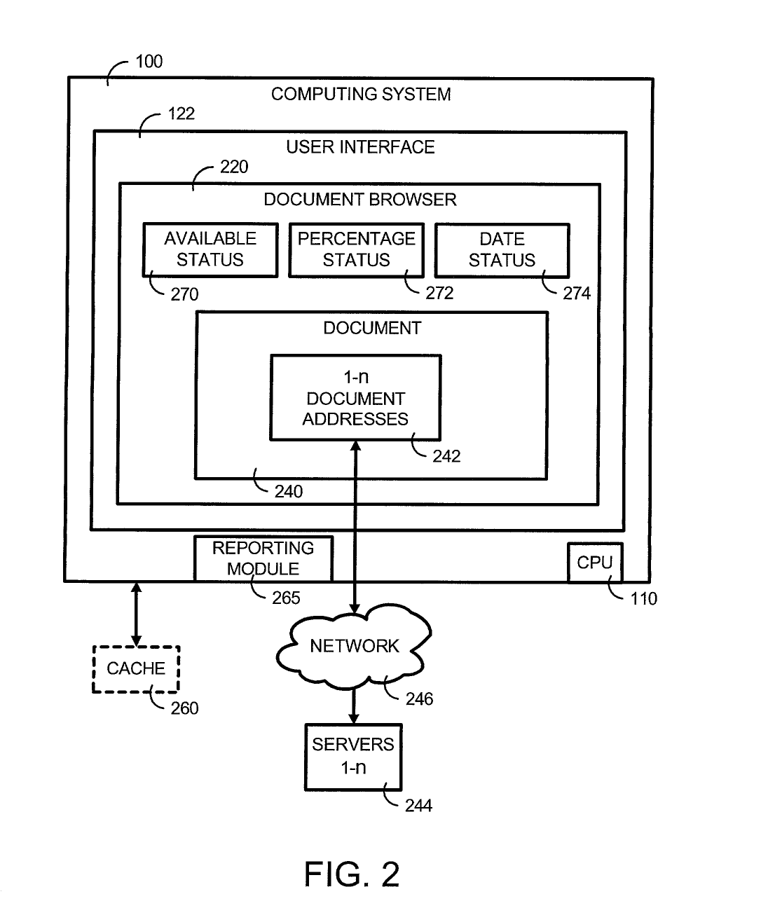

FIG. 2 is a block diagram showing further details of the present invention. The computing system 100 uses the central processing unit 110 for controlling the computational functions of the computing system 100 and also includes the user interface 122 for coupling a document browser 220 with a user with real-time user interaction. User interaction with the computing system 100 is defined as communication from the user with input commands and feedback from the computing system 100 via the user interface 122. The input commands could be, for example, from a keyboard, mouse, trackball, etc. and the feedback could be visual or auditory feedback, which could come from programs operating on the computing system 100 or the Internet.

The document browser 220 can be an Internet browser, or more specifically, a World Wide Web browser. The browser visually displays all type of documents 240 to the user. Each document 240 is comprised of 1-n document addresses 242 that point to other documents located either locally on the computing system or on a 1-n remote servers 244, which is accessed by the computing system 100 via a network connection 246.

The computing system 100 is connected to the remote 1-n servers 244 by any suitable connection, such as a cable, telephone, local area network (LAN) etc. connection. In a network environment using the Internet and World Wide Web, the browser 220 is a web browser that interprets code, such as hypertext mark-up language (HTML), located at certain URL addresses. In this example, the document 240 is a web page that has several other URL addresses 242 pointing to other web pages located on other remote servers. The URL addresses 242 appear on the display 138 while the browser 220 accesses the document 242 associated with the URL.

Typically, when a browser needs to download a file through a URL connection, it normally will first check the hard disk cache and its caching policy to see if a new version needs to be downloaded. If so, the browser will download the file into the cache, and then read the files directly from the cache. This is done to help speed up the loading of the page if the user visits the page at a subsequent date. The portion of the document that is stored is controlled by the browser with preferential settings created by the user or it can be instructed by the document itself with programming scripts, such as JavaScripts or the like embedded within the document.

In the preferred embodiment, as a user browses the World Wide Web, the address and all or portions of each document 220 that is browsed is cached. For example, predefined portions, such as large images, and the associated address are placed in the cache 260 (which is shown with dotted lines because it preferably is a file residing on the computing system's 100 hard drive or on a remote server). A cache reporting module 265 operating on the computer system 100 is coupled to the document browser 220 and cache 260. The module 265 is an active program that gathers the address, availability, percentage and date a document was cached when the document and address are being cached. This information is stored in a separate table. The availability, percentage and date are considered cache status information and are retrieved by the module 265 and shown in the browser 220 after a particular action occurs.

Alternatively, the module 265 is a program that plugs-in to the browser 220 and adds the additional cache status information to a file managing the cache 260 for later retrieval by the module 265. The module 265 is implemented as a program or similar device that is programmed in any suitable programming language, such as C, C++, Java, Perl or the like. Also, the functions are implemented in a plug-in or component object module (COM), such as an Active X component or plug-in.

In addition, a document available status indicator 270, a percentage status indicator 272 and a date status indicator 274 are instructed by the module 265 to work with the browser 220 as graphical indicators for displaying the URL, page availability, percentage of page cached and date the page was cached, respectively.

III. Details of the Operation

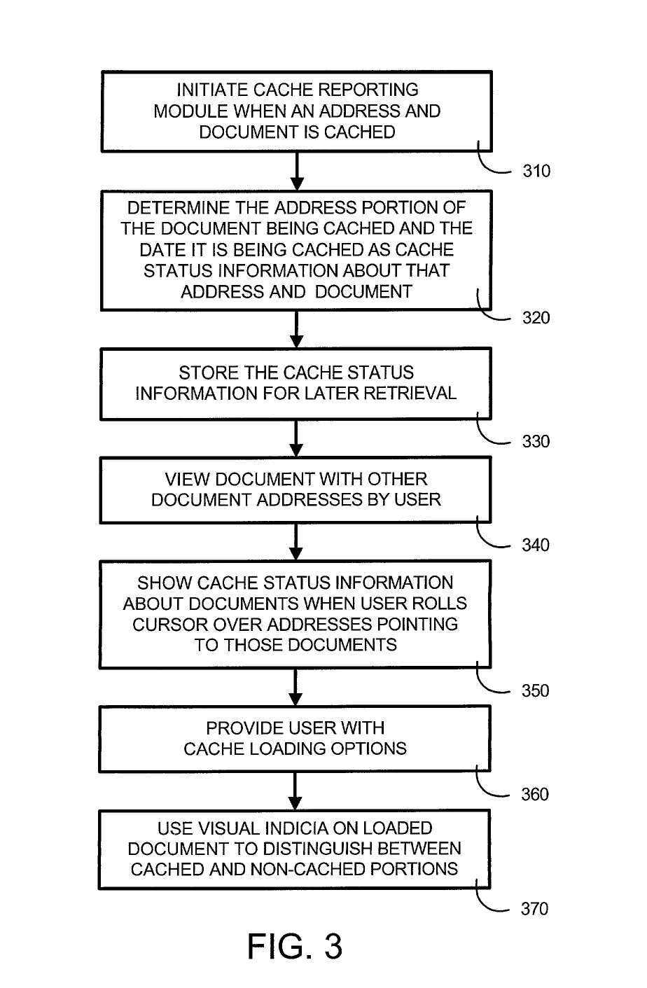

FIG. 3 is a flow chart illustrating operational details of the present invention. Referring to FIG. 3 along with FIGS. 1-2, first, the cache reporting module 265 is initiated when a document is cached (step 310). Second, during caching of a document, the cache reporting module 265 notes that the document is being cached, the percentage of the document being cached, the date the document is being cached and the address as cache status information (step 320).

The module 265 determines the availability of the document by relying on the management file associated with the cache. The module 265 determines the percentage amount of the page that is being cached by analyzing current size aspects of the page and data associated with the page and comparing it to the actual size aspects of the cached document. With regard to the date, the module 265 creates a “time stamp” that is logged in the table or cache file, which is based on the clock associated with the computing system 100.

Third, the cache status information is stored and made accessible in any suitable manner, but preferably it's stored as a separate table on the computing system 100, on a remote server or within a cache file associated with the cache, as described above (step 330). Fourth, the user views a document with several addresses pointing to other documents (step 340). Fourth, if the user rolls the cursor over one or more of the addresses, the module accesses the cache status information and provides the user with the cache status information about the documents that are associated with the particular addresses in a graphical format (step 350).

Fifth, at this point, the user can make an informed decision on whether or not to access the document. Namely, after the user views the cache status information, the user is provided with the following load options: 1) load the cached document; 2) specify portions of the document to be either loaded from the cache or with newly loaded and “fresh” content; or 3) load a completely new or “fresh” document (step 360). A graphical load menu is used to allow the user to select a portion of the document, for instance by right clicking on it, that is desired to be reloaded.

Further, after the chosen document is loaded, visual indicia (such as a color coding scheme or highlighting) is used to distinguish between the portions of the document that are cached and fresh (step 370). Users can then be given the three load options again.

### IV. WORKING EXAMPLE

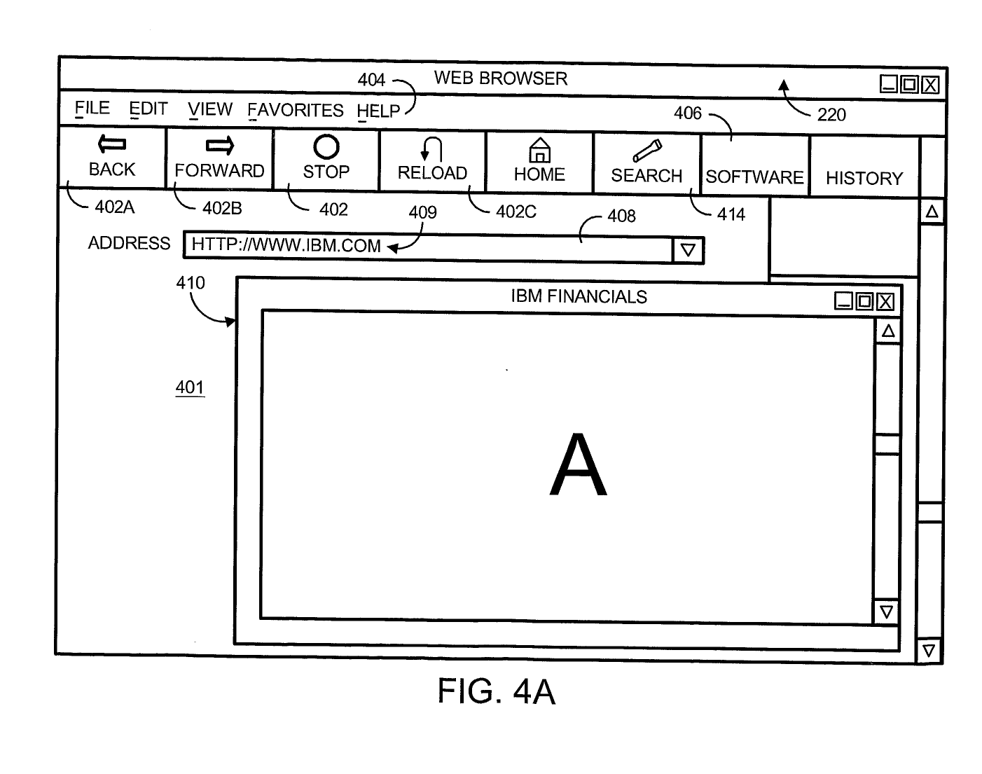

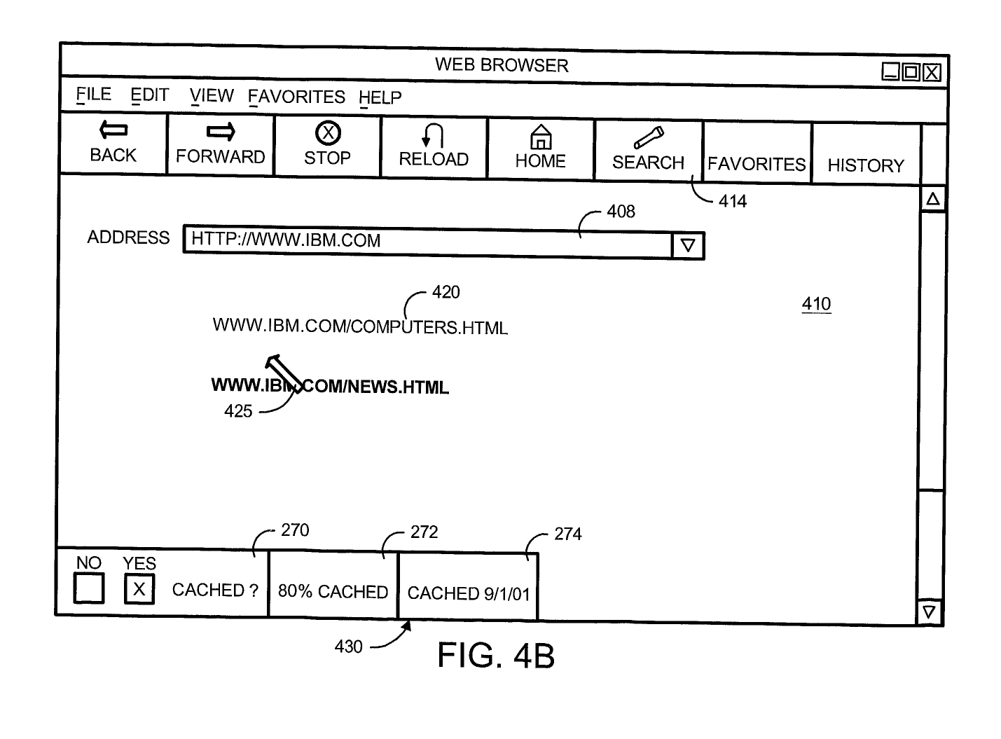

The following is provided in an Internet environment for illustrative purposes only. FIGS. 4A and4B are working examples showing the graphical user interface 220 for the present invention. In an Internet environment, the browser is a World Wide Web browser 220 displayed on a monitor 138 through a graphical user interface (GUI) 122 of a data processing system. The Web browser 220 includes a stop button 402, which halts all connection from the server to the browser. Also, a number of selection buttons 402A and 402B are included that may be used to switch between Web pages that have been retrieved, and 402C, the refresh button, which forces the retrieval of a requested Web page directly from the Web site.

Web browser 220 also includes a drop-down menu display 404 to select items, and alternative selections through button 406. Web browser 220 also has a search parameter field 408 for entering the URL 409 of the selected Web page. The URL 409 can be further explored by selecting the Net Search button 414 resulting in the Web page 410 being downloaded and displayed on the display area 401. The Web page 410 is illustrated having standard borders. In this illustration Web browser 220 has no indication of a cached page which may indicate that the page was not retrieved from the Web browser cache.

Referring to FIG. 4B, when a current document 410 is being viewed, the address of the current document 410 being viewed is shown in an address bar 408. Other documents hyper linked to the current document 410 are represented in the current document 410 by URL addresses 409 pointing to the documents. When the user rolls a cursor 425 over one or more of the URL addresses 420, the module is activated and accesses the cache status information. The user is then provided with a cache status bar 430 that holds the available status indicator 270, the percentage status indicator 272 and the date status indicator 274. In addition, the URL address of the document that the user is pointing to could be included in the cache status bar 430 to show that the URL is in the cache. A flag is used to show this, such as flashing the URL or displaying the word “cached” in the status bar 430.

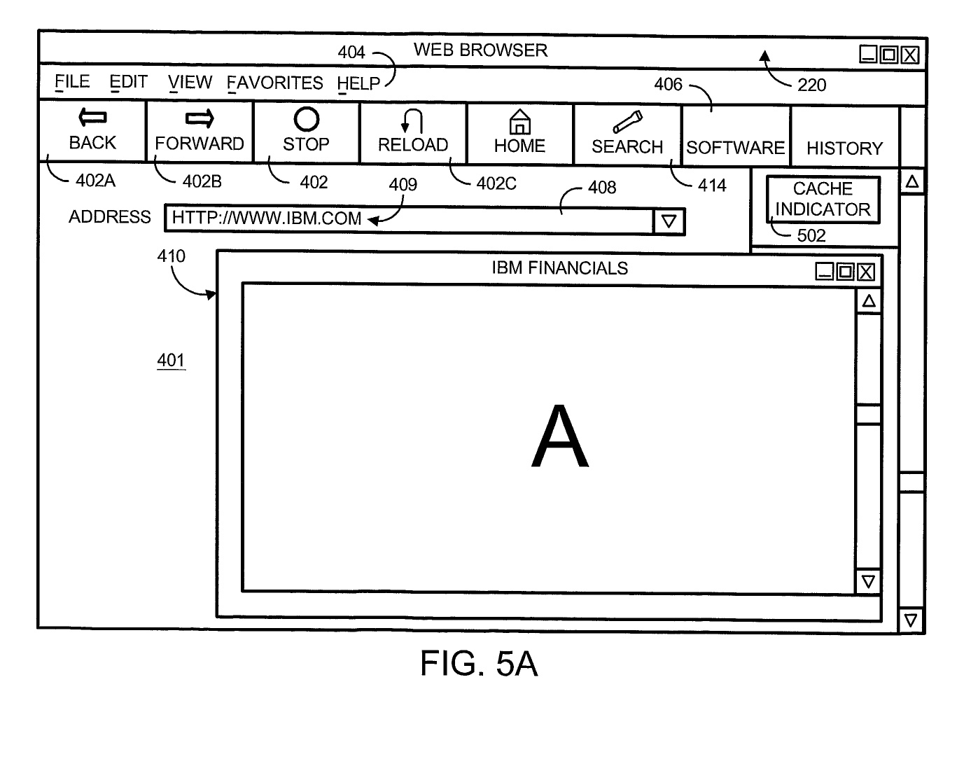

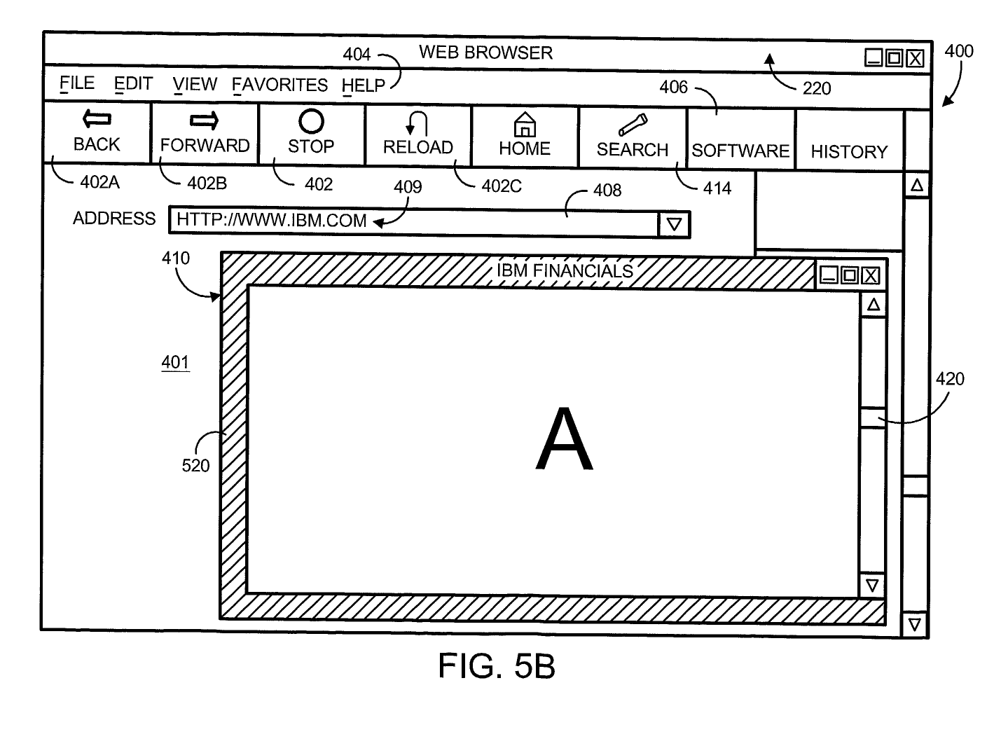

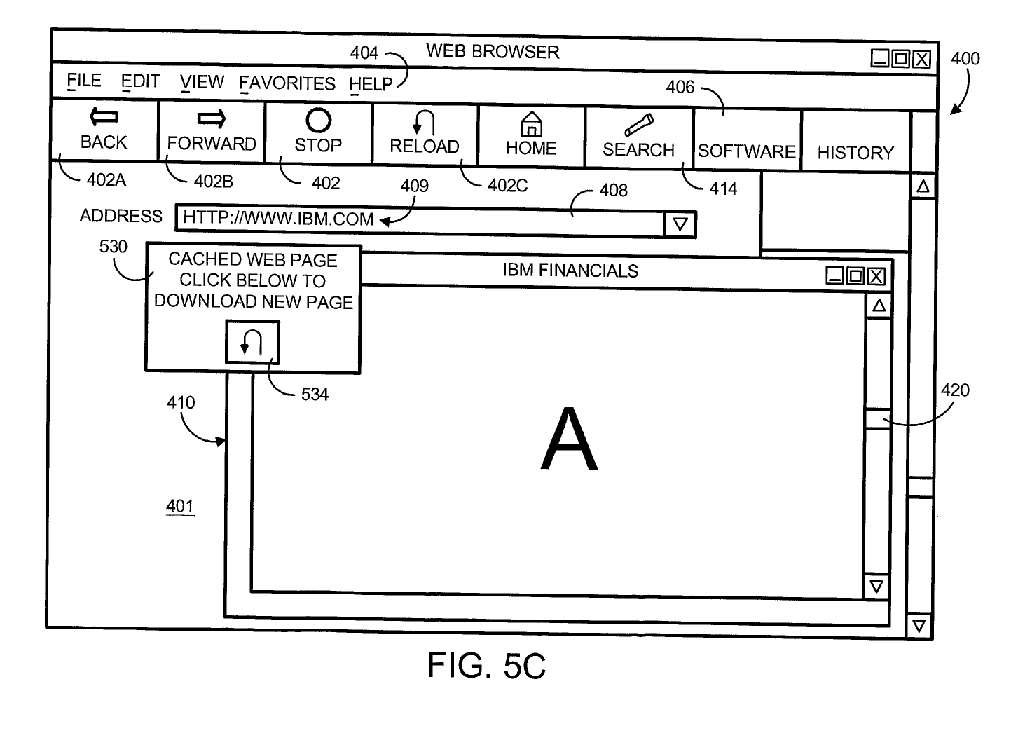

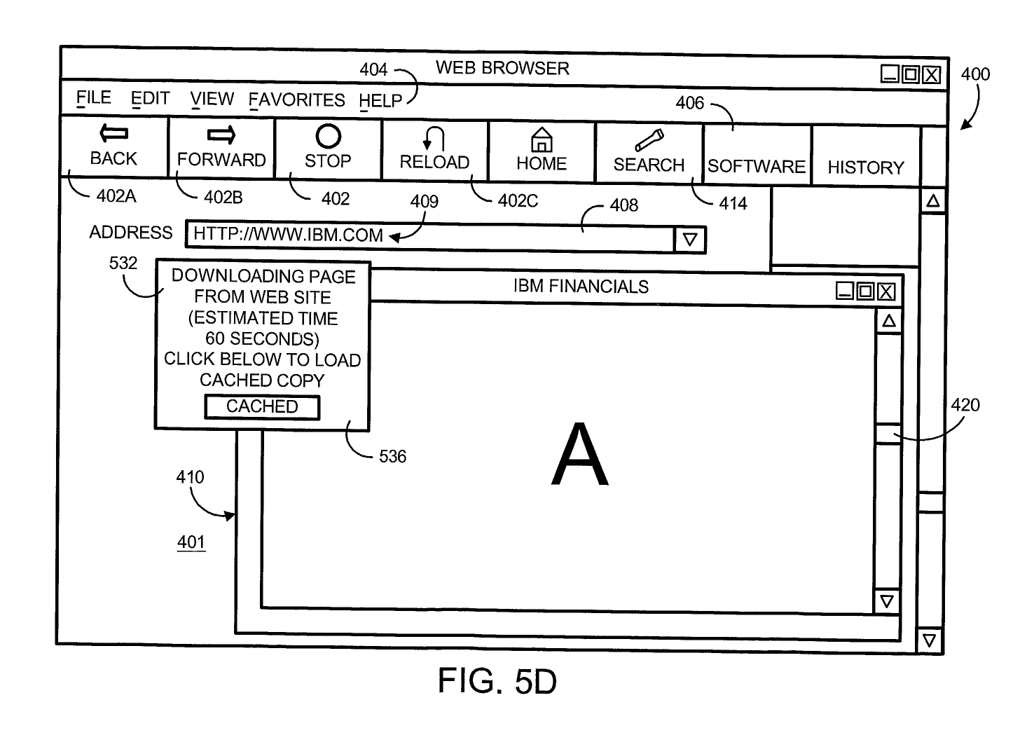

FIGS. 5A and 5B along with FIGS. 4A-4B illustrate the Web browser 220 after the Web page 410 is loaded and determined to be cached. In FIG. 5A, after the user selects the web page and it's loaded, a cache indicator 502 appears in the Web browser 220, and is displayed only when the Web page is cached (in another embodiment it may be a permanent display that is highlighted when the page is cached). The cache indicator 502 may be displayed as a dialogue box prior to displaying the Web page 410, or displayed at pre-determined time intervals, or a user may be able to select the location or method of displaying the cache indicator 502 through the setup location/menu of the application GUI.

FIG. 5B provides a visual scheme to indicate to the user that a page is cached. The border 520 of the Web page 410 is highlighted to indicate that the page is cached. A cache indicator may be a dialogue box 530, 532 as shown in FIGS. 5C and 5D. These boxes 530, 532 not only notify the cache status of the Web page, but also provide options through a second button 534, 536. In FIG. 5C the button is a reload button 534 is linked to the functionality of the browser reload button 402C and utilizes the same functional logic to enable a reload. This feature provides an instantaneous reminder to the user.

The Web browser 220 may also be automatically set to reload the Web page 410 from the Web site. The dialogue box 532 may present the user with an option to cancel the reload as in the case when the information is no longer time relevant. It may also be employed to alert a user when a new page is about to be downloaded and the user wishes to either access the contents of a cached page, or speed up the page retrieval. The dialogue box 532 indicates that a new page is about to be downloaded and the user may select the cancel 536 option. This option would be present when a cached page exists and the user has previously set the Web browser's 220 page request function to retrieve all requests directly from the Web site. This function could also be extended to include an indication of the location of the cached copy of a document from local or proxy sources.

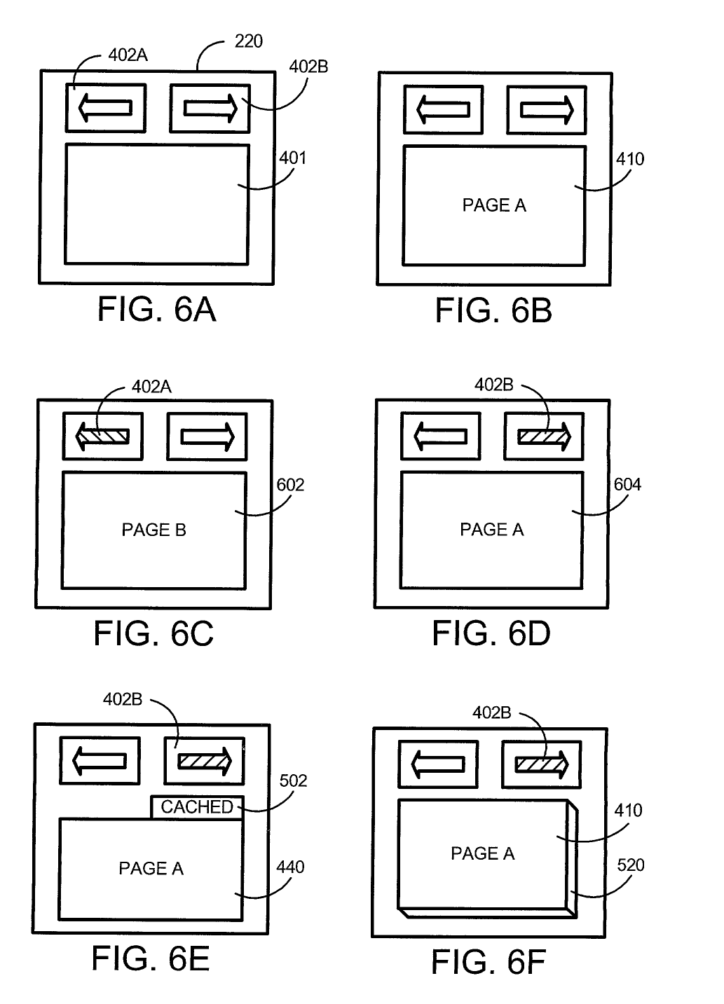

FIGS. 6A-6F illustrate a sequence of downloading and subsequent cache retrieval of a Web page in response to user input. Referring to FIGS. 6A-6B, web page A 410 is downloaded on the Web page area 401 from a remote location (Internet, Intranet). FIG. 6C illustrates a second page B 602 which has been downloaded which causes back button 402A to be highlighted, indicating the user may return to the first downloaded Web page. Once page B 602 is downloaded, the first page A 410 is cached. If the user selects the highlighted return button 402A, a newly downloaded version of page A 604 is displayed; or the originally downloaded and cached Web page 410 is displayed from the local cache of the data processing system. The user is alerted by the cache indicator 502 as shown in FIG. 6E or by a shaded border 520 as shown in FIG. 6F. In each case, where a second Web page is downloaded, forward button 402B is highlighted to permit the user to retrieve page B 602.

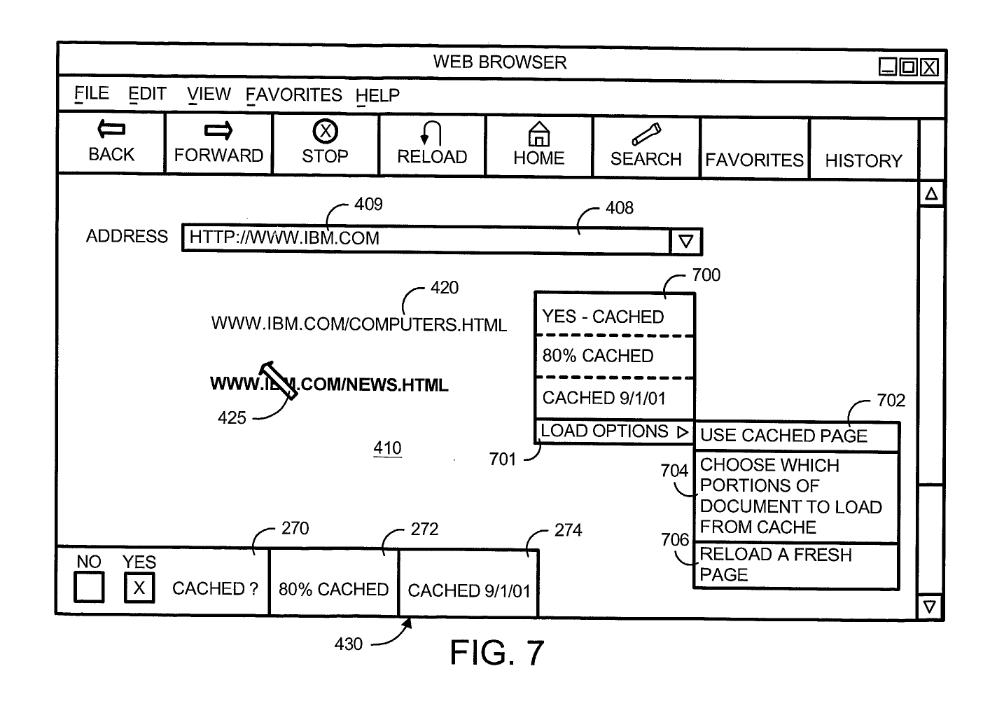

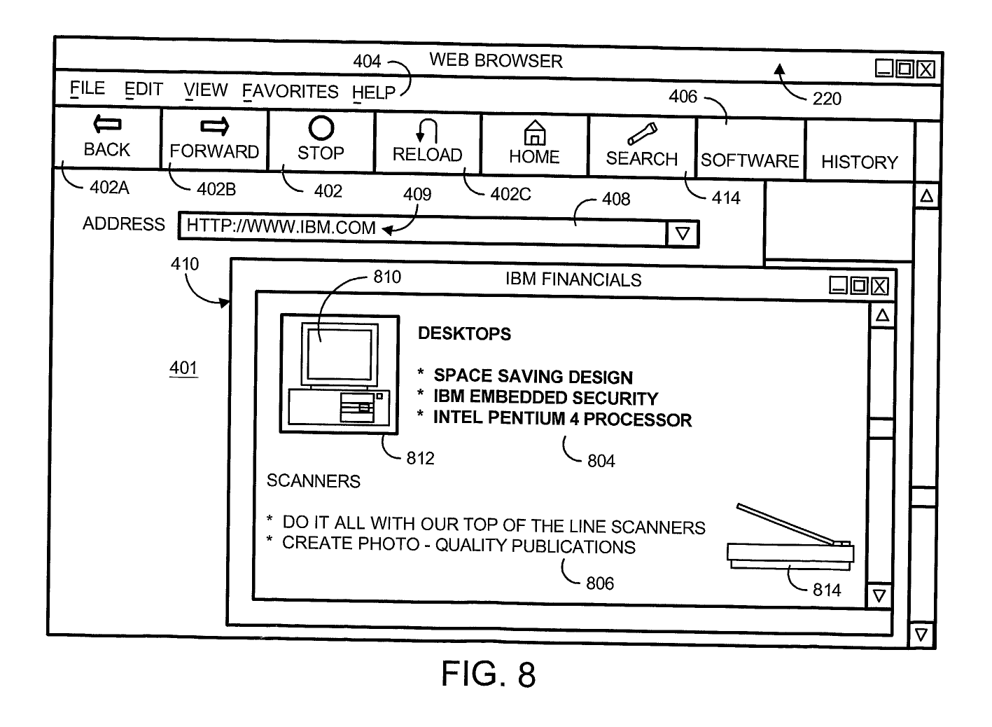

Alternatively to FIGS. 5A-5D, FIG. 7 illustrates further options in another embodiment of the present invention. Referring back to FIGS. 4A-4B along with FIG. 8, in an alternative embodiment, the module is preprogrammed to bring up a floating menu in response to user action, such as the user “right clicking” on the mouse 126 when it is pointing to a URL for displaying a load menu 700. The load menu 700 allows the user to view the cache status information 270, 272, 274 in a pop-up menu format that is located proximate to the URL in question.

Further, after the user views the cache status information 430 or from menu 700, and before the web page is loaded, a user is given load options 701. The load options 701 are an extension of the load menu 700 and include several options. For example, the user is given the following options: 1) load the cached document 702; 2) load designated portions of the document either from the cache or with newly loaded and “fresh” content 704; or 3) load a completely new or “fresh” document 706.

In addition, FIG. 8 illustrates another feature of the present invention. After the user chooses how to load the selected page from the load options 701, visual indicia (such as a color coding scheme or highlighting) is used to distinguish between the portions of the document that are cached and fresh. For instance, text and images on the page are highlighted or color coded with visual indicia to show which portions of the page are cached, and which are fresh. In this case, if the text is fresh, the text will appear in color 1, 804. If the text is cached (or partly cached), the portion of the text that is cached is presented as color 2, 806. Similarly, if an image 810 is fresh, the border would be shown as color 1, 812, but if it were a cached image, the border would be shown as color 2, 814.

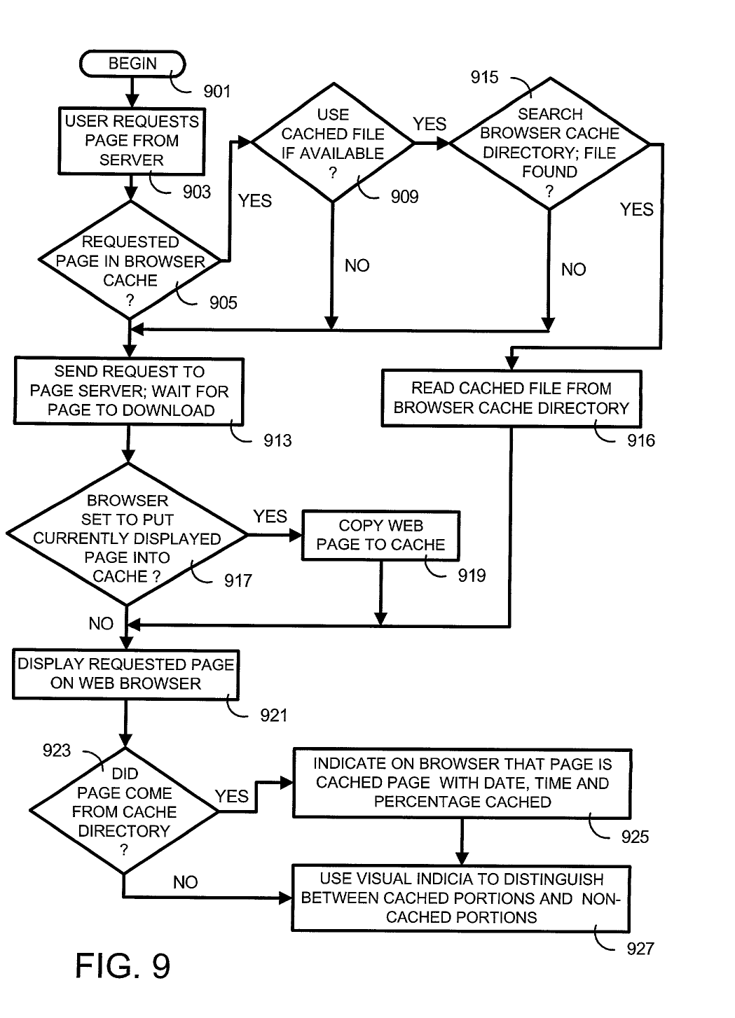

FIG. 9 is a flow chart illustrating the processes of the embodiment described in FIGS. 4A-4B and FIGS. 7-8. The process begins with 901 after the Web browser is executed on the data processing system. The user requests a Web page 903, and the request is processed by a remote server connected to the data processing system via the Internet or Intranet, or alternatively by a local browser cache if it had been downloaded previously. A check is made to determine if the requested page is in the user's browser cache 905. If it is, the user's preference is read and a determination is made whether to use the cached file rather than downloading a file from the server 909.

The user preference may be loaded during setup of the browser application, or on a prompt to the user prior to retrieving the Web page. If the cached file is to used, the processor searches for the cached file in the user's browser cache directory 915. If the cache file is found, it is read from the user's browser cache directory 916. The Web page is then displayed with a cache indicator 917 alerting the user that the displayed Web page was retrieved from the cache. The user may then select the refresh button to force a download from the server via the Internet. When this page is reloaded with a non-cached page Web page, the cached page indicator is removed to show the new status of the displayed page. If the cache file is not found, the remote server is contacted and the Web page downloaded via the Internet 913.

When a new page is downloaded, it is automatically stored in the cache unless the user has changed the browser settings. A check is thus made to determine if the browser is set to store a new page in the cache 917 and the page is stored 919 when it has been set. The requested page is then displayed on the web browser 921. The next determination of the source of the displayed Web page is made 923 whereby, if the page was retrieved from the cache, an indicator is displayed on the Web browser along with the date and the percentage cached 925. Visual indicators are used to distinguish between cached and non-cached portions of the displayed page 927. Last, optionally, the user can then provided with load options of either loading a fresh page or portions of the page.

The description of the present invention has been presented for purposes of illustration and description, but is not intended to be exhaustive or limited to the invention in the form disclosed. Many modifications and variations will be apparent to those of ordinary skill in the art. Therefore, the foregoing description should not be taken as limiting the scope of the invention defined by the appended claims.

What is claimed is:

1. A management process operating on a computer system that has cached documents stored on the computer system, the process comprising:
displaying cache status information about the cached documents when a user digitally points to an address associated with one or more of the cached documents.

2. The process of claim 1, wherein the user rolls a cursor over the address to digitally point to the address.

3. The process of claim 1, wherein the cache status information includes document availability.

4. The process of claim 1, wherein cache status information includes percentage of the document that was previously cached.

5. The process of claim 1, wherein cache status information includes the date the document was cached.

6. The process of claim 1, further comprising analyzing current size aspects of the document and data associated with the document and comparing it to actual size aspects of the cached document and reporting the comparison as the percentage of the document cached.

7. The process of claim 1, further comprising creating a time stamp associated with the computer system and reporting it as the date the document was cached.

8. The process of claim 1, wherein the document is a World Wide Web page that is accessed by an Internet browser and the addresses are uniform resource locators pointing to other World Wide Web pages.

9. The process of claim 1, further comprising allowing a user to selectively choose to load the cached documents from at least one of a local storage area or from a network connection.

10. The process of claim 1, further comprising providing load options including at least one of loading the cached document, loading designated portions of the document from the cache or loading a completely new document.

11. The process of claim 1, further comprising providing visual indicia to distinguish between the portions of the document that are cached and new.

12. The process of claim 11, wherein the visual indicia is a color coded scheme.

13. A computer system having a browser operating thereon for displaying documents, comprising:
a memory device that selectively caches the documents;
a module that tracks status information during caching of the documents; and
a cache status device enabled by the module for displaying the status information when a user digitally points to an address associated with one or more the cached documents.

14. The computer system of claim 13, wherein digitally pointing to the address includes rolling a cursor over the address.

15. The computer system of claim 13, wherein the cache status information includes document availability.

16. The computer system of claim 13, wherein cache status information includes percentage of the document that was previously cached.

17. The computer system of claim 13, wherein cache status information includes the date the document was cached.

18. The computer system of claim 13, wherein the module analyzes current size aspects of the document and data associated with the document, compares it to actual size aspects of the cached document and reports the comparison as the percentage of the document cached.

19. The computer system of claim 13, wherein the document is a World Wide Web page that is accessed by an Internet browser and the addresses are uniform resource locators pointing to other World Wide Web pages.

20. The computer system of claim 13, further comprising load options including at least one of loading the cached document, loading designated portions of the document from the cache or loading a completely new document.

21. The computer system of claim 13, further comprising visual indicia to distinguish between the portions of the document that are cached and new.

22. The computer system of claim 21, wherein the visual indicia is a color coded scheme.

23. A computer-readable medium having computer-executable instructions operating on a computer system for managing document navigation, comprising:
an indicia module that tracks status information during storage of the documents; and
a display device for displaying the status information when a user digitally rolls a cursor over an address associated with one or more of the stored documents.

24. The computer-readable medium of claim 23, wherein the display device includes a status bar for displaying the status information when a user digitally rolls a cursor over an address associated with the stored documents.

25. The computer-readable medium of claim 23, wherein the document is a World Wide Web page that is accessed by an Internet browser and the addresses are uniform resource locators pointing to other World Wide Web pages.

26. The computer-readable medium of claim 23, wherein the module analyzes current size aspects of the document and data associated with the document, compares it to actual size aspects of the cached document and reports the comparison as the percentage of the document cached.

27. The computer-readable medium of claim 23, further comprising load options including at least one of loading the cached document, loading designated portions of the document from the cache or loading a completely new document.

28. The computer-readable medium of claim 23, further comprising visual indicia to distinguish between the portions of the document that are cached and new.

29. The computer-readable medium of claim 28, wherein the visual indicia is a color coded scheme.
